(19) United States
(12) Patent Application Publication
(10) Pub. No.: US 2026/0289010 A1
(43) Pub. Date: Sep. 24, 2026

(54) ON-DEVICE DATA ANONYMIZATION AND VERIFICATION PROTOCOL USING IDLE RESOURCES OF NEURAL PROCESSING UNITS

(71) Applicant: Dell Products L.P., Round Rock, TX (US)

(72) Inventors: RUWAN ASANKA WASALA, Limerick (IE); JEANNIE FITZGERALD, Ennis (IE); ONUR CELEBIOGLU, Austin, TX (US)

(21) Appl. No.: 19/085,647

(22) Filed: Mar. 20, 2025

(51) Int. Cl. G06F 21/62; G06N 20/00; H04L 9/08; H04L 9/32

(52) U.S. Cl. CPC G06F 21/6254; G06N 20/00; H04L 9/0825; H04L 9/3247; H04L 9/3263

(57) ABSTRACT

Methods and systems for secure data anonymization are disclosed. Non-anonymized data stored on a data processing system may be anonymized using idle neural processing unit (NPU) resources of the data processing system. The NPU may host a first large language model (LLM) that performs the data anonymization using the idle NPU resources. The anonymized data may be reviewed, verified, and digitally certified by an accredited entity embodied by a second LLM that is different from the first LLM.

### FIELD

Embodiments disclosed herein relate generally to use of neural processing units (NPUs). More particularly, embodiments disclosed herein relate to systems and methods for using idle resources of NPUs installed in a data processing system (e.g., a computing device) to perform an on-device data anonymization and verification protocol.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIGS. 1C and 1D show data flow diagrams in accordance with one or more embodiments.

FIG. 2 shows a data interaction diagram in accordance with one or more embodiments.

FIG. 3 shows a flowchart in accordance with one or more embodiments.

FIG. 4 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

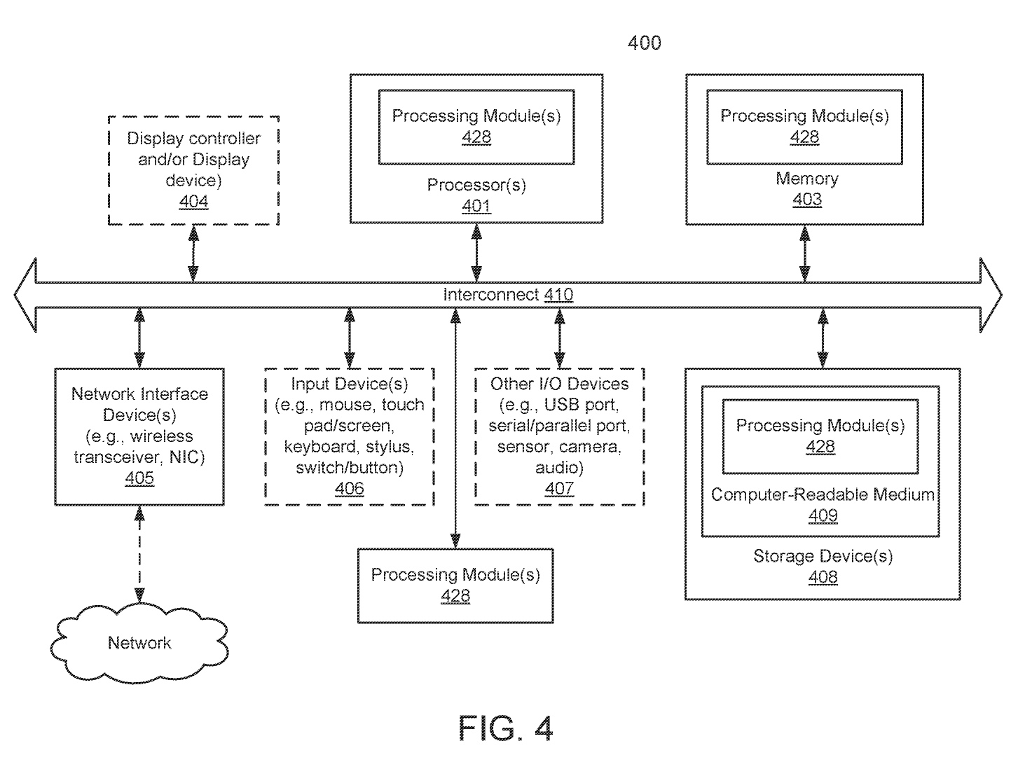

In general, embodiments disclosed herein relate to methods and systems for performing secure data anonymization using idle resources of one or more on-device neural processing units (NPUs) of a data processing system (e.g., computing devices, as described below in reference to FIG. 4).

As artificial intelligence (AI) based technologies continue to advance, special processing units (e.g., graphical processing units (GPUs), NPUs, or similar computer chips) dedicated for AI tasks (e.g., machine learning/AI model training, machine learning/AI model execution, or the like) are developed to ease the burden on existing computing processing units (CPUs) of data processing systems.

For example, an NPU is a dedicated processor or processing unit on a larger system on a chip (SoC) designed specifically for accelerating neural network operations and AI tasks. Unlike general-purpose CPUs and GPUs, NPUs are optimized for a data-driven parallel computing, making them highly efficient at processing massive multimedia data like videos and images and processing data for neural networks. They are particularly adept at handling AI-related tasks, such as speech recognition, background blurring in video calls, and photo or video editing processes like object detection. Additionally, NPUs are integrated circuits but they differ from single-function ASICs (Application-Specific Integrated Circuits). While ASICs are designed for a singular purpose (such as mining bitcoin), NPUs offer more complexity and flexibility, catering to the diverse demands of network computing. They achieve this through specialized programming in software or hardware, tailored to the unique requirements of neural network computations.

In some cases (e.g., in consumer based electronic cases or the like), an NPU may be integrated into the main CPU of a data processing system while in other cases (e.g., at larger data centers or more specialized industrial operations or the like), the NPU might be an entirely discrete processor (e.g., separate from any other processing units) installed on a motherboard of the data processing system.

Since NPUs are specifically designed to implement AI related tasks, an NPU of a data processing system may have more idle time than the CPU of the same data processing system. In particular, while no AI related tasks are being implemented or scheduled, the CPU may be busy executing other processes (e.g., the operating system, non-AI related applications, or the like) while the NPU sits idle. While the NPU sits idle, the computing resources of the idle NPU sits wasted.

Because NPUs are much more expensive and more difficult to obtain than CPUs and GPUs, more effective use of these NPUs is generally desired than to let these NPUs sit idle and go to waste. Thus, embodiments disclosed herein utilize such idle periods of NPUs for execution of tasks that users and/or data processing system may not need but could find helpful (e.g., helpful for the user and helpful for improving the functionalities of the data processing system).

One such task includes the anonymization of data (e.g., user data, organization data, or the like) stored on the data processing system (or within a collection of data processing systems connected together via, for example, an intranet). In particular, large language models (LLMs) have shown remarkable efficiency in Natural Language Processing (NLP) tasks including Named Entity Recognition (NER), a vital step in identifying Personally Identifiable Information (PII). Thus, rather than let an NPU sit idle within a data processing system, the originally intended to be idle NPU may be used to perform on-device data anonymization.

In particular, a plethora of advantages and improvements to computer-related technology and computer functionality can be obtained through such use of idle NPUs. First and most importantly, computing resources of the NPU no longer sit idle and go to waste. Second, by anonymizing or removing PII data directly on the data processing system (or on an intranet environment), the likelihood of private/ personal data leaks is advantageously minimized, as sensitive information is processed before any data is transmitted externally (e.g., to a cloud system/storage). Third, personal data remains confined to the data processing system (on which the NPU is installed/hosted), therefore advantageously maximizing safety and security of data reducing the risk of unauthorized access during transmission of the data or during storage of the data to external sources (e.g., the cloud). Fourth, anonymized or PII-removed data typically reduces storage space, resulting in reduced data volume for storage on the data processing system that directly improves the functionalities (e.g., data storage capacity functionalities or the like) of the data processing system. Fifth, performing the anonymization on-device (e.g., on the data processing system) rather than on a network (e.g., on a remote server) advantageously avoids any negative impacts (e.g., delays resulting from network latency, data loss, or the like) associated with transmission of data over a network. Finally, on-device data anonymization also directly improves data sharing practices and technology as concerns over data privacy are significantly alleviated (e.g., with on-device anonymization, users are likely to feel more comfortable sharing their data, addressing the reluctance seen in scenarios where only a minority (less than 40%) of connected laptops share data since on-device anonymization assures users that their data, even when uploaded or shared, remains untraceable and secure from potential threats), which further improves advancements in technology (importantly, AI based technologies that require such access and use of vast quantities of data) in general as open sharing of anonymized data (e.g., telemetry or the like) advantageously facilitates the enrichment of research and the development of more effective AI and non-AI based solutions.

In addition to using idle NPUs (also referred to herein as “idle NPU resources”) of a data processing system for performing on-device (and/or intranet-based) data anonymization, embodiments disclosed herein introduces an additional protocol to ensure that the anonymized data is both compliant (e.g., in terms of one or more inter-organization based, industry based, globally based standards) and verifiable.

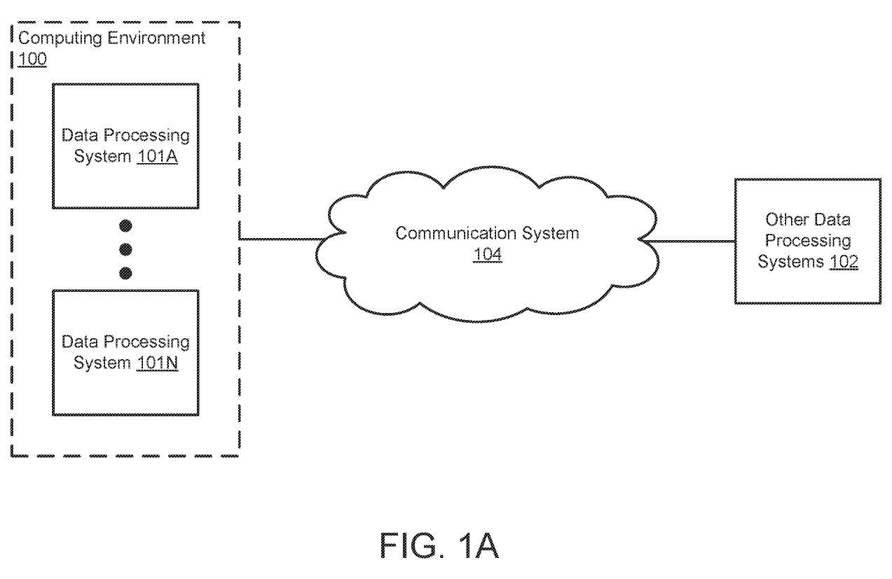

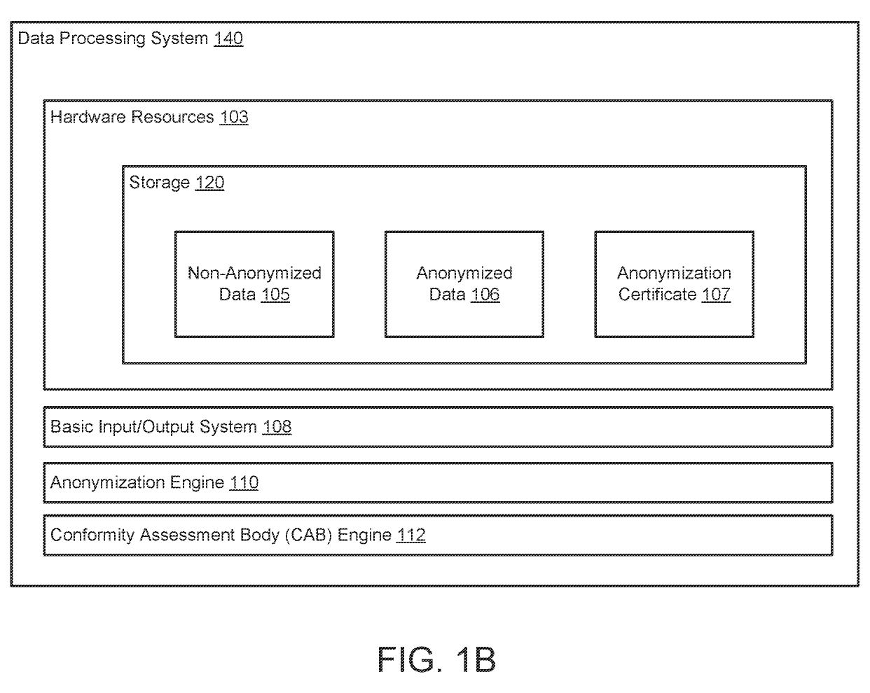

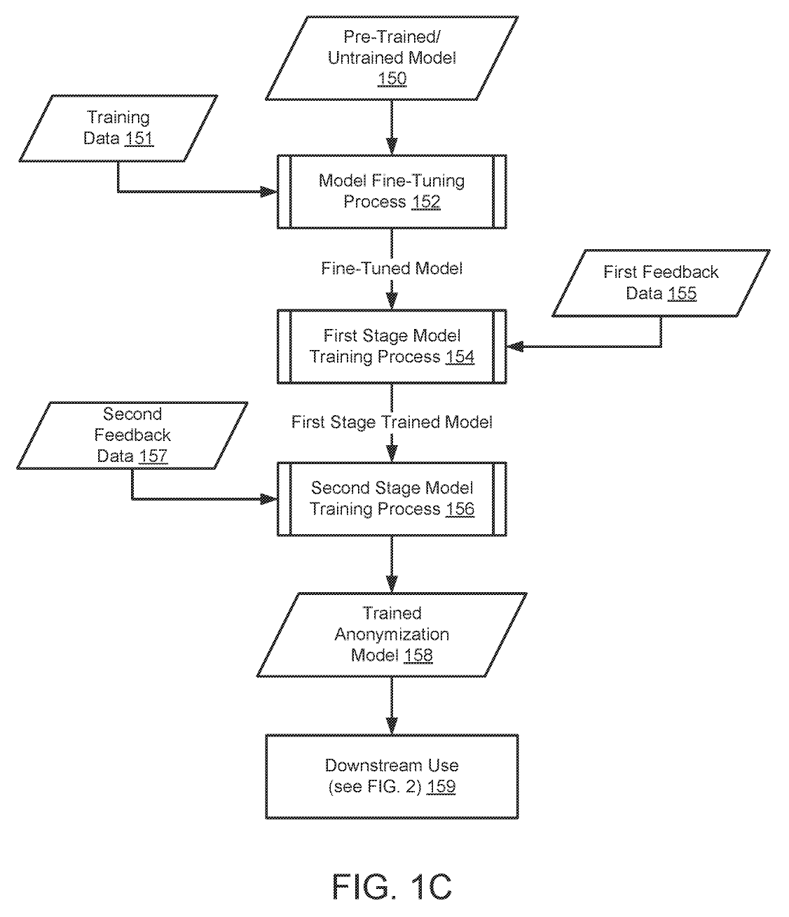

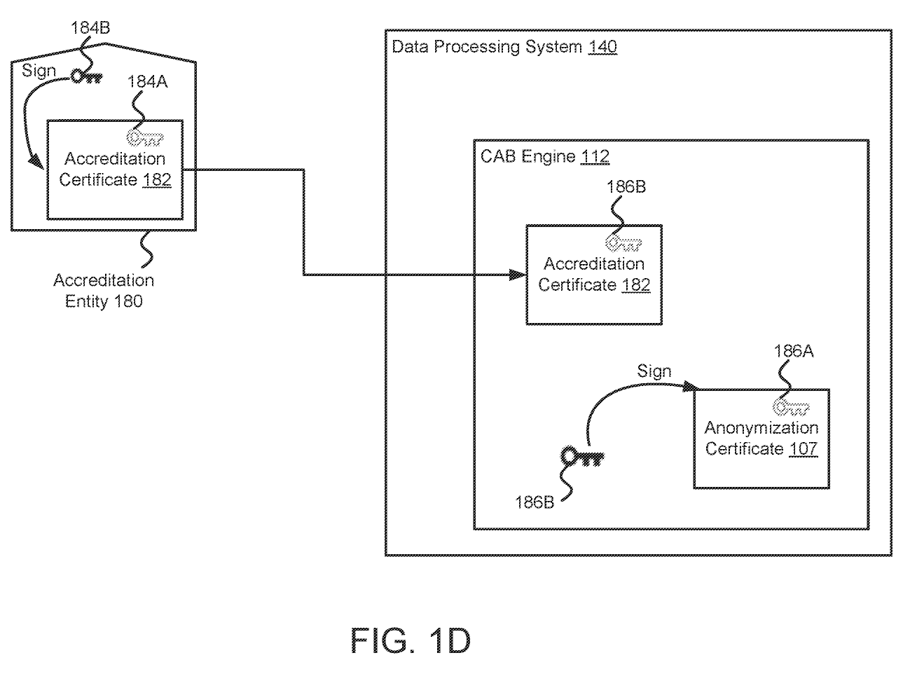

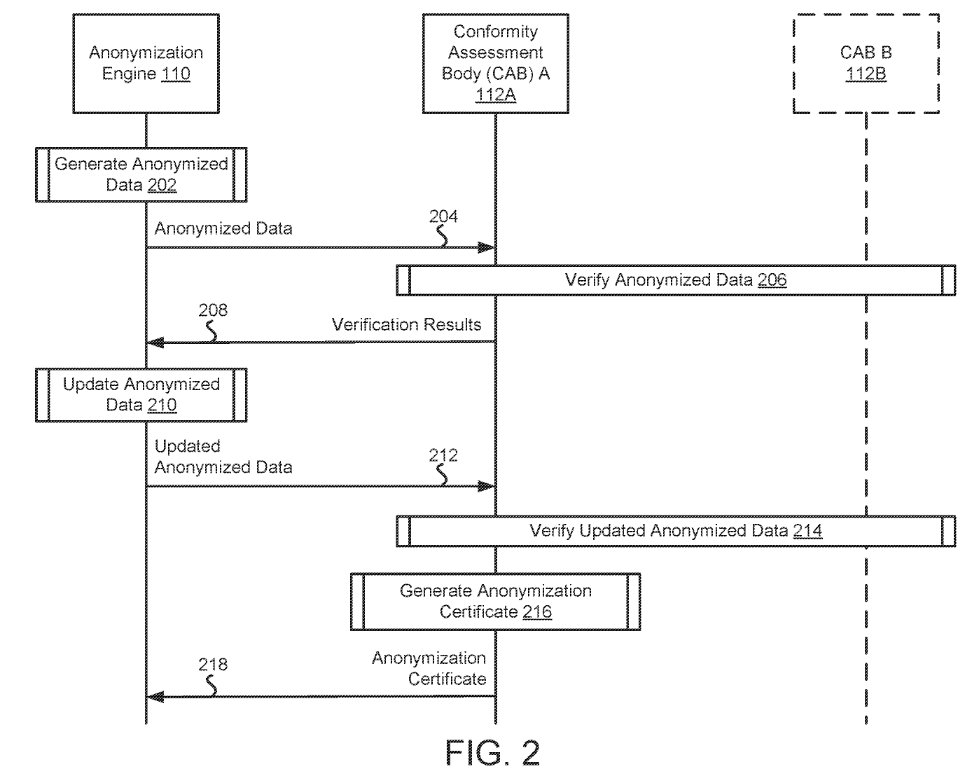

In particular, an NPU of a data processing system may be configured to host a conformity assessment body (CAB) LLM that analyzes, validates, and verifies anonymized data (e.g., the on-device anonymized data using the idle NPUs) for anonymization compliance (e.g., based on any of the above-listed standards) based on a robust peer-review process. Digital certifications (e.g., in the form of signed digital certificates or the like) may then be issued to the anonymized data to indicate anonymization compliance. Blockchain technology may also be used to host (e.g., store) such digital certification for added authenticity and security. Additional details regarding such a verification protocol are discussed below in refernce to FIGS. 1D and 2.

The addition of such a verification protocol further improves data anonymization technology through the addition of data authentication, verification, and security layers to convention data anonymization practices. In particular, what conventional data anonymization practices lack in ethical data treatment (e.g., based on one or more standards) is advantageously provided using the verification protocol of embodiments disclosed herein.

Other advantages, improvements to various technologies (including the above-discussed data anonymization technology, AI technology, technology in general, etc.), and improvements to computer functionalities will be apparent below as more details regarding embodiment disclosed here are described.

In an embodiment, a method for secure data anonymization is provided. The method may include: obtaining data for anonymization from a storage of a data processing system; anonymizing, using a first trained large language model (LLM), the data to obtain anonymized data; obtaining, from a second trained LLM different from the first trained LLM, an anonymization certificate for the anonymized data after the anonymized data has been verified by the second trained LLM, the second trained LLM being an accredited data anonymization entity, and the anonymization certificate being digitally signed by the second trained LLM using a private key generated by the second trained LLM for the anonymized data and the first trained LLM; and storing the anonymized data and the anonymization certificate in the storage to replace the data with the anonymized data.

The data is anonymized using idle neural processing unit (NPU) resources of the data processing system on which the first trained LLM is hosted, the idle NPU resources are associated with at least one NPU of the data processing unit, the at least one NPU is separate from a central processing unit (CPU) of the data processing system.

The anonymization certificate comprises a public key generated by second trained LLM for the anonymized data, the private key and the public key forming an anonymization compliance key pair for verifying an anonymization compliance of the anonymized data.

The second trained LLM is hosted on a second data processing system separate from the data processing system.

The private key is generated using a unique identification (ID) of the first trained LLM combined with a unique ID of the data.

The private key is generated using a hash of a configuration of the first trained LLM combined with a unique ID of the data.

Anonymizing the data using the first trained LLM comprises performing a data anonymization and verification process, the data anonymization and verification process comprises: performing a first anonymization of the data to obtain a once anonymized data; providing the once anonymized data to the second trained LLM for verification; obtaining, from the second trained LLM, verification results for the once anonymized data, the verification results comprising the anonymization certificate or instructions to refine the anonymized data; and when the instructions comprise the instructions to refine the anonymized data, refining the once anonymized data to obtain updated anonymized data, wherein the data anonymization and verification process is repeated until the first trained LLM receives the anonymization certificate from the second trained LLM.

The data anonymization and verification process further comprises and by the first trained LLM: generating, while anonymizing the data and while refining the once anonymized data, explainability data to be provided to the second trained LLM, the explainability data indicates to the second trained LLM one or more reasons as to why certain information in the once anonymized data and in the updated anonymized data are anonymized by the first trained LLM.

Anonymizing the data using the first trained LLM comprises training an untrained LLM into the first trained LLM, the training comprises: fine-tuning, during a first training stage, the untrained LLM on synthetic datasets and real datasets that are focused on assisting the untrained LLM in an identification of personal data to obtain a fine-tuned LLM; training, during a second training stage, the fine-tuned LLM using Deep Reinforcement Learning (DRL) based techniques utilizing reward engineering to obtain a first-stage trained LLM; and further training, during a third training stage, the first-stage trained LLM using Reinforcement Learning from Human Feedback (RLHF) based techniques to obtain the first trained LLM.

The method may further include: storing the anonymization certificate on blockchain.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, AI services and/or any other type of service that may be implemented with a computing device.

To provide the above noted functionality, the system of FIG. 1A may include any number of data processing systems 101A-bN that make up a computing environment 100. Computing environment 100 may be any type of environment (e.g., a deployment, a remote server, a corporation’s office, a single user, or the like) where one or more of the data processing systems 101A-101N may be hosted and used to provide computer implemented services to one or more users.

Each data processing system 101A-101N may be a node within the computing environment 100. One or more nodes may then be combined and/or arranged into one or more clusters (e.g., one or more groups of data processing systems), each of which having at least one of the nodes. Additionally, data processing systems 101A-101N may provide the computer implemented services to users of data processing systems 101A-101N and/or to other devices (not shown). Different data processing systems may provide similar and/or different computer implemented services.

To provide the computer implemented services, data processing systems 101A-101N may include various hardware components (e.g., various types of processors, memory modules, storage devices, etc.) and host various software components (e.g., operating systems, application, machine learning model, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 101A-101N may host various services that provide the computer implemented service (e.g., application services, data anonymization services, data verification services, or the like) and/or that manage the operation of these services (e.g., management services). The aggregate (e.g., combination) of the management and application services may be a complete service that provide desired functionalities.

Any of the components illustrated in FIG. 1A may be operably connected to each other (and/or components not illustrated) with communication system 104. In an embodiment, communication system 104 includes one or more networks that facilitate communication between any number of components (e.g., computing environment 100 with other data processing systems 102 making up other environments over the network). The networks may include wired networks and/or wireless networks (e.g., and/or the Internet). The networks may operate in accordance with any number and types of communication protocols (e.g., such as the Internet Protocol).

In embodiments, within the computing environment 100, the data processing systems 101A-101N may be connected via a local area network (LAN) based protocol to form an intranet setting between the data processing systems 101A-101N.

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 101A-101N and/or any of the other data processing systems 102 shown in FIG. 1A.

To provide computer implemented services (e.g., data anonymization services, data verification services, or the like), data processing system 140 may include any quantity of hardware resources 103. Hardware resources 103 may include physical parts of data processing system 140 that store and run software. Hardware resources 103 may include processors (e.g., CPUs, GPUs, NPUs), memory modules (also referred to herein as “memory devices”), storage devices, and/or other types of hardware components usable to provide computer implemented services. A basic input/output system (BIOS) 108 may be stored on the processors and memory modules.

Storage 120 may be implemented using any combination of storage devices (e.g., hard disk drives (HDDs), solid state drives (SSDs), volatile memory, non-volatile memory, or the like). Storage 120 may be configured to store non-anonymized data 105, anonymized data 106, and one or more anonymization certificates 107.

In embodiments, non-anonymized data 105 may be any type (e.g., any and all kinds) of data stored on data processing system (e.g., telemetry data, log data, documents, files, images, videos, or the like) that has not yet been anonymized (e.g., by the anonymization engine 110). Anonymized data 106 may be made up of any number and/or combination of formerly non-anonymized data that has been anonymized (and/or verified) by the anonymization engine 110 and conformity assessment body (CAB) engine 112, respectively. In embodiments, each anonymized data 106 (e.g., each piece, grouping of, or the like may be associated with at least one anonymization certificate 107, which will be discussed in more detail below in reference to FIG. 1D.

BIOS 108 may be used to startup data processing system 140. On the startup, BIOS 108 may configure peripheral devices, such as a keyboard, mouse, monitor, etc. With the peripheral devices, BIOS 108 may configure hardware resources 103 for use by data processing system 140.

Anonymization engine 110 may be implemented using hardware, software, or a combination thereof. For example, anonymization engine 110 may be configured using a large language model (LLM) hosted on an NPU making up the hardware resources 103 of the data processing system 140. The LLM may be specifically configured (e.g., instantiated and trained) as a data anonymization LLM that anonymizes data stored on the data processing system 140 (e.g., the non-anonymized data stored in storage 120). Additional details regarding the functions and training of the data anonymization LLM are discussed below in reference to FIG. 1C.

CAB engine 112 may be implemented using hardware, software, or a combination thereof. For example, CAB engine may be configured using another LLM (referred to herein as a “CAB LLM”) hosted on the NPU that is different from the data anonymization LLM of the anonymization engine 110. The CAB LLM may be trained using any known methods and techniques associated with LLM training. The CAB LLM may be configured to review, verify, and authenticate the anonymized data 106 generated by the data anonymization LLM of the anonymization engine 110. Additional details regarding the functions of the CAB LLM are discussed below in reference to FIG. 1C.

In embodiments, the anonymized data 106 may be generated on-device within a single data processing system 140 and/or within multiple data processing systems 140 connected via an intranet environment without utilizing any remote network resources (e.g., a remote server on the network, or the like). The on-device data anonymization may be generated when the NPUs of the data processing system(s) 140 are indicated (e.g., via a status label, via a work queue of the NPU(s), or the like) to be idle. Said another way, the NPUs are determined (e.g., by the data processing system 140) to be idle when the data processing system 140 assess that there is nothing for the NPU to do within a predetermined period of time (e.g., 30 minutes, 1 hour, etc.) and/or if a status of an NPU indicates that it is currently idle.

Once an NPU is determined to be idle (or even partially idle with some NPU resources being labeled as idle while other NPU resources of the same NPU are executing other AI tasks), the resources of these idle NPUs (or partially idle NPUs) may be configured by the data processing system 140 (e.g., via instructions/commands from the CPU, the NPU’s independent processor core, or the like) to start performing data anonymization on the non-anonymized data 105 stored in storage 120 to start (e.g., essentially as a background process of the NPUs) replacing one or more of the non-anonymized data 105 with the anonymized data 106. This advantageously utilizes idle NPU resources that would have went to waste as the NPUs sit idle and also directly improves the functionalities of the data processing system by freeing up memory space in the storage 120 through the replacement of non-anonymized data 105 with the anonymized data 106 (namely, since anonymized data 106 uses significantly less storage space (e.g., limited storage resources of storage 120) than the non-anonymized data 105. Further, since NPUs are specifically designed for AI tasks and are more cumbersome (or even simply not designed) to be used for non-AI tasks (e.g.., graphics processing similar to GPUs and operating system management similar to CPUs), ensuring that none of the NPUs become idle or stay in the idle state for too long advantageously provides a more effective/efficient use of these NPUs.

Additionally, the on-device data anonymization process (e.g., via a single computing device or within an intranet setting) advantageously avoids any negative impacts (e.g., delays resulting from network latency, data loss, or the like) associated with transmission of data over a network (e.g., transmitting the non-anonymized data 105 to a remote network server for anonymization and then receiving the anonymized data 106 back from the remote network server).

To implement the on-device data anonymization, in one example, a single data processing system 140 may be configured to include both the anonymization engine 110 and the CAB engine 112. This configuration may be referred to herein as the single host dual-LLM verification configuration where a single data processing system 140 (e.g., a single computer) hosts both the data anonymization LLM and the CAB LLM to perform both the data anonymization and data verification processes using its own internally installed NPU(s).

In another example, a single data processing system 140 may be configured with only one of the anonymization engine 110 or the CAB engine 112. This configuration may be referred to herein as the intranet dual-LLM verification configuration where one data processing system 140 (e.g., data processing system 101A of FIG. 1A) within environment 100 of FIG. 1A hosts the data anonymization LLM and another/different (e.g., a separate) data processing system (e.g., data processing system 101N of FIG. 1A) within environment 100 of FIG. 1A hosts the CAB LLM. In this intranet dual-LLM verification configuration, a single data processing system 140 (e.g., a single computer) is only configured to be in charge of one portion (e.g., the data anonymization portion or the data verification portion) of the processes (e.g., herein collectively referred to as the “data anonymization and verification protocol”) of embodiments disclosed herein within an intranet setting. This intranet dual-LLM verification configuration imitates a peer-review process while ensuring that data (anonymized or non-anonymized) remain within the intranet while the data (e.g., the anonymization of the data) is verified.

In embodiments, whether a data processing system 140 is (or data processing systems are) configured to operate in the single host dual-LLM verification configuration or in the intranet dual-LLM verification configuration may depend on a variety of factors including, but not limited to: (i) a preference of an entity/user that owns the data processing system(s); (ii) limited computing resources available to the data processing system (e.g., whether the NPU of a single data processing system 140 is capable of hosting both or only one of the data anonymization LLM and CAB LLM; (iii) security requirements of the entity/user; or the like.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in refernce to FIG. 4.

Turning now to FIG. 1C, FIG. 1C shows a data flow diagram illustrating a process for instantiating and training the data anonymization LLM of the anonymization engine 110. In the data flow diagram of FIG. 1C, components and data (e.g., trained or untrained models, time-series data, or the like) are shown using a first set of shapes (e.g., 150, 151, 157, etc.), processes using the data and/or components are shown using a second set of shapes (e.g., 152, 154, 156, etc.), and uses of the data and/or components are shown using a third set of shapes (e.g., 159).

As shown in FIG. 1C, a pre-trained/untrained model 150 may first be obtained. The pre-trained/untrained model 150 may be a LLM that has not yet been configured (e.g., trained) any specific tasks and/or has been minimally configured (e.g., with the necessary libraries, etc.) to perform a specific function (namely, in the context of embodiments disclosed herein, the pre-trained/untrained model 150 may be minimally configured for data anonymization tasks).

In embodiments, the pre-trained/untrained model 150 may be obtained from any source without departing from the scope of embodiments disclosed herein. In one example, the pre-trained/untrained model 150 may be created by the entity associated with environment 100 (e.g., of FIG. 1A) using propriety code or using open-source code. In another example, the pre-trained/untrained model 150 may be downloaded from the network (e.g., the Internet) from one or more online developer’s website.

The pre-trained/untrained model 150 may be ingested into model fine-tuning process 152 along with training data 151. As part of model fine-tunning process 152 any suitable LLM-based fine-tuning techniques may be applied to the pre-trained/untrained model 150 may without departing from the scope of embodiments disclosed herein. The training data 151 used for the model fine-tuning process 152 may be made up of one or more synthetic and/or real datasets focuses on helping the pre-trained/untrained model 150 may understand and identify various types of personal data (e.g., PII or the like).

Once fine-tuned, the fine-tuned LLM model may be ingested along with first feedback data 155 into a first stage model training process 154. In this first stage model training process 154, the fine tuned LLM model may be further refined using Deep Reinforcement Learning (DRL) approaches/techniques that prioritize higher rewards (e.g., via the first feedback data 155) for effective identification and anonymization of data as well as generating reasoning (e.g., justifications, explanations, or the like) behind the model’s anonymization strategy. Said another way, this first stage model training process 154 utilizes reward engineering (e.g., via human and/or machine feedback) to improve the model’s capabilities in personal/PII data detection/identification, removal/anonymization of such personal/PII data, and generation of an explainability of such removal/anonymization.

Other LLM training techniques/protocols (beside DRL) that achieve the same effects may also be used as part of the first stage model training process 154 without departing from the scope of embodiments disclosed herein.

As further shown in FIG. 1C, the first stage trained model (that has completed the first stage model training process 154) (also referred to herein as a “first-stage trained LLM”) is then ingested into a second stage model training process 156 along with second feedback data 157. In this second stage model training process 156, the first stage trained model is further refined using Reinforcement Learning from Human Feedback (RLHF) approaches/techniques to train the first stage trained model on anonymization verification tasks that involve identifying omitted (e.g., by mistake) or non-anonymized data and suggesting appropriate method for anonymization for such types of data. Said another way, the second stage model training process 156 may utilize the second feedback data 157 similar to a discriminator role in a generative adversarial network (GAN) setting to further fine-tune/train the first stage trained model on the mode’s data anonymization capabilities.

Other LLM training techniques/protocols (beside RLHF) that achieve the same effects may also be used as part of the second stage model training process 156 without departing from the scope of embodiments disclosed herein.

Once the second stage model training process 156, a trained anonymization model 158 (e.g., the data anonymization LLM of data anonymization engine 110) may be obtained. By utilizing a three step (e.g., one fine-tuning and two training steps) process, the data anonymization LLM of embodiments disclosed herein may advantageously: (i) identify and handle diverse personal data types; (ii) accurately process and remove/anonymize personal data; and (iii) justify/explain the identification and processing (e.g., removal/anonymization) of the personal data.

Once the trained anonymization model 158 is obtained, the trained inference trained anonymization model 158 may (as discussed above) be applied to one or more downstream uses (e.g., used in the data anonymization and verification protocol of embodiments disclosed herein). Such downstream uses are further discussed below in refernce to FIGS. 1D and 2.

In embodiments, the model training process shown in FIG. 1C may be performed by the data processing system 140 hosting the anonymization engine 110. Alternatively, the model training process shown in FIG. 1C may be performed may be performed by a separate computing device (e.g., any other data processing system) with the trained anonymization model 158 then being provided (e.g., transmitted) to be hosted by the data processing system 140 hosting the anonymization engine 110 (e.g., as a dynamically updated mirror copy of the trained anonymization model 158 that is continuously updated and further refined on the separate data processing system). For example, each time the trained anonymization model 158 is updated on the separate computing device, the data processing system 140 hosting the anonymization engine 110 will also receive (e.g., as a mirror copy) the updated version of the trained anonymization model 158.

Turning now to FIG. 1D, a data flow diagram describing the functionalities of the CAB engine 112 is provided.

Initially, the CAB engine 112 (namely, the CAB LLM of the CAB engine 112) may obtain accreditation from one or more recognized national or international accreditation bodies (e.g., the Institute of Electrical and Electronics Engineers (IEEE), or the like). This accreditation serves as an attestation that the CAB LLM is competent and meet the necessary requirements set forth in relevant data standards, thereby authorizing the CAB LLM to perform conformity assessment activities. These activities are defined in standards, which the data anonymization LLM is expected to adhere to, guided by review recommendations generated by the CAB LLM. To engage in conformity assessment activities, the CAB LLM must demonstrate its expertise and capability, which is assessed and validated through respective accreditation processes of the one or more recognized national or international accreditation bodies. These processes advantageously ensure that the CAB LLM is qualified to determine if the activities it oversee meet the stipulated requirements. Once accredited, the CAB LLM is empowered to issue digital certifications to anonymized data (e.g., anonymized data 106 generated by the data anonymization LMM), affirming the compliance with the applicable data anonymization standards. In embodiments, all CAB LLMs hosted by any number of data processing systems 140 via CAB engine 112 must be accredited by at least one recognized national or international accreditation body.

As shown in FIG. 1D, once a CAB LLM has been accredited, the respective recognized national or international accreditation body (e.g., accreditation entity 180) may generate (e.g., issue) an accreditation certificate 182 in the form of a digital certificate and provide the accreditation certificate 182 to the CAB engine 112 hosting the accredited CAB LLM. In embodiments, the accreditation certificate 182 may include a public key 184A (e.g., shown in FIG. 1D using a non-shaded key icon) generated by the accreditation entity 180 for the accredited CAB LLM. This public key 184A may be made widely available (e.g., on the Internet, on a blockchain system, etc.) and can be used by anyone (e.g., the public) wanting to verify the accredited CAB LLM’s credentials.

In embodiments, this public key 184A may be generated using one or more information unique to the specific accredited CAB LLM. For example, the public key 184A may be generated based on one (or a combination) of the specific accredited CAB LLM’s unique attributes such as, but not limited to: (i) a version number of the specific accredited CAB LLM; (ii) the specific accredited CAB LLM’s training dataset characteristics; (iii) the specific accredited CAB LLM’s operating environment (e.g., unique identifications (IDs) of the data processing system 140 hosting the CAB LMM including the ID of the data processing system 140 itself and/or unique IDs of any of the hardware resources 103 including the NPU); (iv) evaluation metrics of the specific accredited CAB LLM; (v) specific algorithm(s) employed by the specific accredited CAB LLM; or the like). This ensures that the public key 184A is intricately linked to the specific and unique characteristics of the specific accredited CAB LLM, advantageously making the public key 184A more secure and less prone to being replicated or misused (namely, improving the security of the public key 184A. Moreover, such generation of the public key 184A also advantageously makes the public key 184A easier to trace and uniquely identify the specific accredited CAB LLM.

As also shown in FIG. 1D, the accreditation entity 180 may also generate (e.g., for the CAB LLM) a private key 184B that may be used to digitally sign the accreditation certificate 182. This private key 184B may be generated as a pair (e.g., as a private-public key pair) with public key 184A using the same type of information (or slightly different combination of information) used to generate the public key 184A. However, unlike public key 184A, private key 184B may be securely stored exclusively by the accreditation entity 180 (e.g., not made available to the public).

As further shown in FIG. 1D, the CAB engine 112 hosting the CAB LLM may generate anonymization certificate 107. In embodiments, this anonymization certificate 107 may be generated for each piece of anonymized data received by the CAB LLM from the data anonymization LLM. Said another way, once an accredited CAB LLM verifies that anonymized data meets the standards that the CAB LLM is configured to enforce (e.g., the standards of at least the accreditation entity 180 that accredited the CAB LLM), the CAB LLM generates the anonymization certificate 107 for the anonymized data to indicate that the anonymized data is compliant (e.g., meets standards). The verification process performed by the CAB LLM is described in more detail below in reference to FIG. 2.

Along with anonymization certificate 107, the CAB engine 112 may generate anonymization certificate public key 186A and include the anonymization certificate public key 186A with the anonymization certificate 107. The CAB engine 112 may also generate anonymization certificate private key 186B and use anonymization certificate private key 186B to sign anonymization certificate 107. Anyone who wants/needs to verify the compliance of the data anonymization LLM’s anonymized data (e.g., 106 of FIG. 1B) can do so by using the anonymization certificate public key 186A. By using this anonymization certificate public key 186A, any entity can decrypt the signature on the anonymization certificate 107 to confirm that the anonymization certificate 107 was indeed issued by the accredited CAB LLM.

In embodiments, the anonymization certificate private key 186B may be securely held by the CAB engine 112 and never shared (e.g., not distributed and only stored by CAB engine 112) while the anonymization certificate public key 186A may be provided to the public to allow the public to validate the authenticity of the anonymization certificate 107 (namely, that the anonymization certificate 107 was indeed generated by an accredited CAB LLM).

The anonymization certificate private key 186B may be generated by the CAB engine 112 specifically for the data anonymization LLM that provided the anonymized data for verification. In particular, the anonymization certificate private key 186B may be generated (e.g., by CAB engine 112) using one or more of the specific data anonymization LLM’s unique attributes including, but not limited to: (i) the specific data anonymization LLM’s ID; (ii) a hash of the specific data anonymization LLM’s configuration (e.g., underlying code and/or algorithm or the like); (iii) a unique ID of one or more datasets the data anonymization LLM processes; or the like. For example, in embodiments, the anonymization certificate private key 186B may be generated using a combination of (i) and (iii) or a combination of (ii) and (iii). Using a combination of two unique attributes ensures that the anonymization certificate private key 186B is deeply connected to the specific data anonymization LLM and its operation context, which advantageously enhances security, traceability, and ensuring that the anonymization certificate private key 186B is only valid for that single specific data anonymization LLM and/or the dataset(s) utilized by the single specific data anonymization LLM.

In embodiments, in case of updates to the CAB LLM (e.g., if the CAB LLM needs to undergo re-accreditation/re-attestation) and/or in case of updates to the data anonymization LLM (e.g., if the data anonymization LLM and/or its dataset changes), the respective private-public key pairs (e.g., the 184A and 184B pair and the 186A and 186B pair) would also be updated and/or re-generated to reflect the updates to the CAB LLM and/or the data anonymization LLM.

Additionally, to further improve the credibility and authenticity of the certificates and key pairs (e.g., 182, 107, 184A, 184B, 186B, 186A), any of these components (except for the private keys of the respective key pairs) may be stored into a blockchain environment to make these components immutable.

To further clarify embodiments disclosed herein, an interaction diagram in accordance with an embodiment is shown in FIG. 2. In the interaction diagram of FIG. 2, processes performed by and interactions between components of a system in accordance with an embodiment are shown. In the diagrams, components of the system are illustrated using a first set of shapes (e.g., 110, 112A, 112B, etc.), located towards the top of each figure. Solid lines descend from this first set of shapes to indicate that the devices are operating during the corresponding period of time. Broken lines may be used to show optional elements/components within the interaction diagram of FIG. 2.

Processes performed by the components of the system are illustrated using a second set of shapes (e.g., 202, 210, 216, etc.) superimposed over these lines. Interactions (e.g., communication, data transmissions, etc.) between the components of the system are illustrated using a third set of shapes (e.g., 204, 208, 212, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 204 may occur prior to (or simultaneously with) the interaction labeled as 208. However, it will be appreciated that the processes and interactions may be performed in different orders, any may be omitted, and other processes or interactions may be performed without departing from embodiments disclosed herein.

As shown in FIG. 2, an anonymization engine 110 may generate anonymized data (e.g., 106, FIG. 1B) in process 202. As discussed above in refernce to FIG. 1B, the anonymized data may be generated using non-anonymized data (e.g., 105, FIG. 1B) stored in a data processing system (e.g., 140, FIG. 1B). The process 202 may be performed by anonymization engine 110 as an on-device process (e.g., using the single host dual-LLM verification configuration or the intranet dual-LLM verification configuration).

Once the anonymized data is generated, the anonymization engine 110 (e.g., at interaction 204) provides (e.g., transmits) the anonymized data to a CAB A 112A. In embodiments, the anonymized data may be transmitted along with explainability data. As discussed in reference to FIG. 1C, the explainability data may include any type of information generated by the data anonymization LLM to explain its anonymization process and choices/decisions to the CAB A 112A.

Upon receiving the anonymized data (and the explainability data accompanying/associated with the anonymized data), the CAB A 112A may verify (e.g., as process 206) the anonymized data. As discussed in reference to FIG. 1D, the CAB A 112A may verify the anonymized data using a set of rules/standards that it is configured with that is also accredited by an accreditation entity (e.g., 180, FIG. 1D). As part of process 206, the CAB A 112A may also use the explainability data to understand the workings and processes of the data anonymization LLM and to determine what more (if needed) needs to be done by the data anonymization LLM for the anonymized data to be compliant with CAB A’s 112A standards.

In embodiments, optionally, should CAB A 112A determine that it does not have sufficient resources (e.g., idle and/or non-idle NPU resources) to perform the verification of the anonymized data, CAB A 112A may solicit/delegate another CAB B 112B (e.g., in the intranet dual-LLM verification configuration) to perform part of the verification. This CAB B 112B may be a mirror copy of CAB A 112A that is hosted on a different data processing system and/or a different CAB LLM that has the same accreditation as CAB A 112A. Although only one additional CAB (e.g., CAB B 112B) is shown, any number of additional CABs may be utilized by CAB A 112A without departing from the scope of embodiments disclosed herein.

Once the anonymized data is verified, CAB A 112A (with or without the assistance of CAB B 112B) generates verification results that are provided back (e.g., as part of interaction 208) back to anonymization engine 110. The verification results may include any kind of information that indicates an outcome (e.g., a pass, a fail, a needs updating outcome) of the verification of the anonymized data. The verification results may also include collated feedback generated by the CAB A 112A (and the CAB B 112B if it is utilized) to help (e.g., instruct) anonymization engine 110 further anonymize (e.g. update) the anonymized data. For example, any of the CABs (112A or 112B) may assume additional LLM-based roles to clarify and brainstorm solutions for the anonymization engine 110 to better anonymize the anonymized data to conform to the standards required by the CABs.

Upon receiving the verification results in interaction 208, the anonymization engine 110 may update the anonymized data (e.g., in process 210). In particular, the anonymization engine 110 may use the collated feedback and other information included in the verification results to re-anonymize (e.g., update) the anonymized data into an updated anonymized data, which is then provided back to CAB A 112A (via interaction 212) to be re-verified by CAB A 112A (and CAB B 112B if this CAB is utilized) in process 214.

In embodiments, a minimum of two reviews by an accredited CAB (e.g., CAB A 112A and/or CAB B 112B) may be required. This advantageously ensures that the anonymization performed by the anonymization engine 110 meets satisfactory levels before the CABs finalize the process for digital signature (e.g., using anonymization certificate 107 of FIG. 1B).

In particular, as shown in FIG. 2, once the CAB(s) have determined that the anonymization by the anonymization is satisfactory (e.g., is compliant with the CAB(s)’s standards), CAB A 112A that first received the anonymized data may generate an anonymization certificate (e.g., 107, FIG. 1B) for the anonymized data in process 216. This anonymization certificate may then be provided back (e.g., as part of verification results by CAB A 112A) to the anonymization engine 110 (e.g., via interaction 218).

In embodiments, once the anonymization engine 110 receives the anonymization certificate 107 from CAB A 112A, the anonymization engine 110 stores the anonymization certificate 107 along with the respective anonymized data into storage (e.g., storage 120, FIG. 1B) to replace the non-anonymized version of the data with the anonymized data and the anonymization certificate 107.

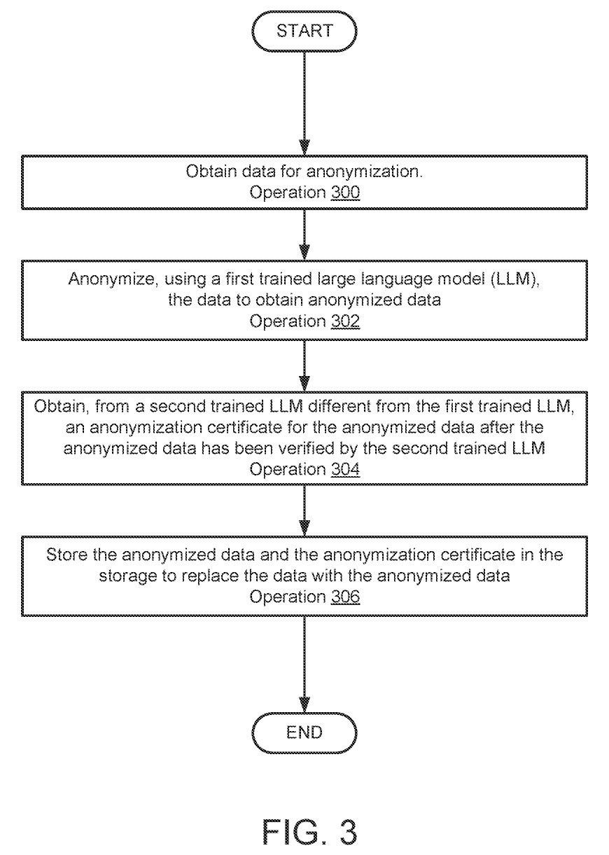

As discussed above, the components of FIGS. 1A-2 may perform various methods for managing secure data anonymization and verification using an on-device idle NPU resource utilization process. FIG. 3 illustrates an example of a method that may be performed by the components of FIGS. 1A-2. For example, any of the data processing systems 101A-101N may perform all or a portion of the methods. In the diagrams discussed below and shown in FIG. 3, any of the operations may be repeated, performed in different orders, and/or performed in parallel with or in a partially overlapping in time manner with other operations. Additionally, the process depicted in the flowchart of FIG. 3 may be performed using idle NPU resources of one or more NPU(s) hosted by a data processing system.

Starting at Operation 300 of FIG. 3, as discussed above in reference to FIGS. 1B-2, data for anonymization may be obtained. For example, non-anonymized data stored in a storage of a data processing system may be obtained by an anonymization engine of a data processing system to be anonymized into anonymized data.

At Operation 302, and as discussed above in reference to FIGS. 1B-2, the data may be anonymized by a first trained large language model (LLM) to obtain the anonymized data. The first trained LLM may be a data anonymization LLM hosted by the anonymization engine (configured using one or more NPUs) of the data processing system. The anonymization may be performed using idle NPU resources of the NPUs while the NPU(s) and/or portions of the NPU(s) are determined (e.g., by the data processing system) to be idle.

At Operation 304, and as discussed above in reference to FIGS. 1B-2, an anonymization certificate may be obtained for the anonymized data after the anonymized data has been verified by a second trained LLM. The second trained LLM may be the CAB LLM discussed in reference to FIGS. 1B-2.

In embodiments, prior to obtaining the anonymization certificate, the anonymized data may have been updated at least once by the anonymization engine (e.g., based on feedback and other information included in verification results provided by the CAB LLM) and re-transmitted to the CAB LLM for re-verification.

At Operation 306, and as discussed above in reference to FIGS. 1B-2, the anonymized data may be stored (along with the anonymization certificate) in a storage of the data processing system. In embodiments, the anonymized data may replace a non-anonymized version of the anonymized data that is currently being stored in the storage.

The process of FIG. 3 may end following Operation 306.

Although embodiments disclosed herein have been described using a local, on-device/intranet setting, they are not limited to such a configuration. Namely, embodiments disclosed herein may also be applied to a network setting where idle NPU resources are shared (e.g., rented, sold, used in cooperatively, or the like) between data processing systems of different environments (e.g., 100, FIG. 1A) separated by the network (e.g., communication system 104 of FIG. 1A). For example, the idle NPU resources of data processing systems 101A-101N of environment 100 may be shared (e.g., rented out, shared with, used cooperatively with, sold to, etc.) with any of the other data processing systems 102 that are separated from environment 100 by communication system 104. Said another way, the idle NPU resources of environment 100 may be provided to the other data processing system 102 in an as-a-service (aaS) manner, similar to a digital idle NPU resource marketplace setting.

Additionally, although idle NPU resources are specifically mentioned herein, embodiments disclosed herein are not limited to the use of these idle resources. More specifically, non-idle resources of NPUs (and/or even idle and/or non-idle resources of CPUs and GPUs of the data processing system) may also be used without departing from the scope of this invention. Other types of processing units (e.g., data processing units (DPUs), language processing unit (LPU), tensor processing units (TPUs), or the like) may also be used to execute the processes and methods of embodiments discussed herein.

Furthermore, although LLMs are specifically mentioned throughout this disclosure, one having ordinary skill in the art would appreciate that any other types of generative AI models (e.g., multi-modal models that handle text, images, and videos; generative adversarial networks (GANs); or the like) may also be used instead of LLMs without departing from the scope of embodiments disclosed herein.

Any of the components illustrated in FIGS. 1A-3 may be implemented with one or more computing devices. Turning to FIG. 4, a block diagram illustrating an example of a computing device (also referred to herein as “system 400”) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system-on-a-chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for secure data anonymization, the method comprising:
obtaining data for anonymization from a storage of a data processing system;
anonymizing, using a first trained large language model (LLM), the data to obtain anonymized data;
obtaining, from a second trained LLM different from the first trained LLM, an anonymization certificate for the anonymized data after the anonymized data has been verified by the second trained LLM, the second trained LLM being an accredited data anonymization entity, and the anonymization certificate being digitally signed by the second trained LLM using a private key generated by the second trained LLM for the anonymized data and the first trained LLM; and
storing the anonymized data and the anonymization certificate in the storage to replace the data with the anonymized data.

2. The method of claim 1, wherein the data is anonymized using idle neural processing unit (NPU) resources of the data processing system on which the first trained LLM is hosted, the idle NPU resources are associated with at least one NPU of the data processing system, the at least one NPU is separate from a central processing unit (CPU) of the data processing system.

3. The method of claim 2, wherein the anonymization certificate comprises a public key generated by second trained LLM for the anonymized data, the private key and the public key forming an anonymization compliance key pair for verifying an anonymization compliance of the anonymized data.

4. The method of claim 3, wherein the second trained LLM is hosted on a second data processing system separate from the data processing system.

5. The method of claim 4, wherein the private key is generated using a unique identification (ID) of the first trained LLM combined with a unique ID of the data.

6. The method of claim 4, wherein the private key is generated using a hash of a configuration of the first trained LLM combined with a unique ID of the data.

7. The method of claim 2, wherein anonymizing the data using the first trained LLM comprises performing a data anonymization and verification process, the data anonymization and verification process comprises:
performing a first anonymization of the data to obtain a once anonymized data;
providing the once anonymized data to the second trained LLM for verification;
obtaining, from the second trained LLM, verification results for the once anonymized data, the verification results comprising the anonymization certificate or instructions to refine the anonymized data; and
when the instructions comprise the instructions to refine the anonymized data, refining the once anonymized data to obtain updated anonymized data, wherein the data anonymization and verification process is repeated until the first trained LLM receives the anonymization certificate from the second trained LLM.

8. The method of claim 7, wherein the data anonymization and verification process further comprises and by the first trained LLM:
generating, while anonymizing the data and while refining the once anonymized data, explainability data to be provided to the second trained LLM, the explainability data indicates to the second trained LLM one or more reasons as to why certain information in the once anonymized data and in the updated anonymized data are anonymized by the first trained LLM.

9. The method of claim 2, wherein anonymizing the data using the first trained LLM comprises training an untrained LLM into the first trained LLM, the training comprises:
fine-tuning, during a first training stage, the untrained LLM on synthetic datasets and real datasets that are focused on assisting the untrained LLM in an identification of personal data to obtain a fine-tuned LLM;
training, during a second training stage, the fine-tuned LLM using Deep Reinforcement Learning (DRL) based techniques utilizing reward engineering to obtain a first-stage trained LLM; and
further training, during a third training stage, the first-stage trained LLM using Reinforcement Learning from Human Feedback (RLHF) based techniques to obtain the first trained LLM.

10. The method of claim 1, further comprising:
storing the anonymization certificate on a blockchain.

11. A non-transitory machine-readable medium having instructions stored therein, which when executed by a processor, cause the processor to perform operations for secure data anonymization, the operations comprising:
obtaining data for anonymization from a storage of a data processing system;
anonymizing, using a first trained large language model (LLM), the data to obtain anonymized data;
obtaining, from a second trained LLM different from the first trained LLM, an anonymization certificate for the anonymized data after the anonymized data has been verified by the second trained LLM, the second trained LLM being an accredited data anonymization entity, and the anonymization certificate being digitally signed by the second trained LLM using a private key generated by the second trained LLM for the anonymized data and the first trained LLM; and
storing the anonymized data and the anonymization certificate in the storage to replace the data with the anonymized data.

12. The non-transitory machine-readable medium of claim 11, wherein the data is anonymized using idle neural processing unit (NPU) resources of the data processing system on which the first trained LLM is hosted, the idle NPU resources are associated with at least one NPU of the data processing system, the at least one NPU is separate from a central processing unit (CPU) of the data processing system.

13. The non-transitory machine-readable medium of claim 12, wherein the anonymization certificate comprises a public key generated by second trained LLM for the anonymized data, the private key and the public key forming an anonymization compliance key pair for verifying an anonymization compliance of the anonymized data.

14. The non-transitory machine-readable medium of claim 13, wherein the second trained LLM is hosted on a second data processing system separate from the data processing system.

15. The non-transitory machine-readable medium of claim 14, wherein the private key is generated using a unique identification (ID) of the first trained LLM combined with a unique ID of the data.

16. A data processing system comprising:
a central processing unit (CPU); and
a memory coupled to the CPU to store instructions, which when executed by the CPU, cause the CPU to perform operations for secure data anonymization, the operations comprising:
obtaining data for anonymization from a storage of a data processing system;
anonymizing, using a first trained large language model (LLM), the data to obtain anonymized data;
obtaining, from a second trained LLM different from the first trained LLM, an anonymization certificate for the anonymized data after the anonymized data has been verified by the second trained LLM, the second trained LLM being an accredited data anonymization entity, and the anonymization certificate being digitally signed by the second trained LLM using a private key generated by the second trained LLM for the anonymized data and the first trained LLM; and
storing the anonymized data and the anonymization certificate in the storage to replace the data with the anonymized data.

17. The data processing system of claim 16, wherein the data is anonymized using idle neural processing unit (NPU) resources of the data processing system on which the first trained LLM is hosted, the idle NPU resources are associated with at least one NPU of the data processing system, the at least one NPU is separate from the CPU of the data processing system.

18. The data processing system of claim 17, wherein the anonymization certificate comprises a public key generated by second trained LLM for the anonymized data, the private key and the public key forming an anonymization compliance key pair for verifying an anonymization compliance of the anonymized data.

19. The data processing system of claim 18, wherein the second trained LLM is hosted on a second data processing system separate from the data processing system.

20. The data processing system of claim 19, wherein the private key is generated using a unique identification (ID) of the first trained LLM combined with a unique ID of the data.
